(19) United States
(12) Patent Application Publication
(10) Pub. No.: US 2015/0029321 A1
(43) Pub. Date: Jan. 29, 2015

(54) MEASURING SYSTEM AND MEASURING METHOD

(71) Applicant: Panasonic Corporation, Osaka (JP)

(72) Inventors: Norihiro IMAMURA, Osaka (JP); Michihiro YAMAGATA, Osaka (JP); Yoshimitsu NOGUCHI, Gifu (JP)

(21) Appl. No.: 14/483,734

(22) Filed: Sep. 11, 2014

Related U.S. Application Data
(63) Continuation of application No. PCT/JP2014/000250, filed on Jan. 20, 2014.

(30) Foreign Application Priority Data
Jan. 21, 2013 (JP) 2013-008053

(51) Int. Cl. G01N 21/59; G06K 9/46; H04N 5/232

(52) U.S. Cl. CPC G01N 21/59; H04N 5/23293; G06K 9/4661
USPC 348/77; 348/136

(57) ABSTRACT

A measuring system includes: a projecting section Q which is configured to project an image in a predetermined pattern as light within multiple regions of an object; an image capturing section A which is configured to capture the object including those multiple regions; and an arithmetic section G which is configured to calculate and output the degree of light propagated through those multiple regions of the object based on the object's image information that has been gotten by the image capturing section A.

This is a continuation of International Application No. PCT/JP2014/000250, with an international filing date of Jan. 20, 2014, which claims priority of Japanese Patent Application No. 2013-008053, filed on Jan. 21, 2013, the contents of which are hereby incorporated by reference.

### BACKGROUND

1. Technical Field

The present application relates to a system for measuring the degree of translucency of an object's skin.

2. Description of the Related Art

Japanese Laid-Open Patent Publication Nos. 2009-213729, 2009-240644 and 2011-130806 disclose methods for measuring the degree of translucency (or clarity) of an object's skin, or sense of translucency to be given to the viewer by his or her skin, using an image sensor.

Specifically, Japanese Laid-Open Patent Publication No. 2009-213729 discloses a method for determining the degree of translucency of an object's skin by the area and state of distribution of a spotlight which has been cast onto his or her skin.

On the other hand, Japanese Laid-Open Patent Publication No. 2009-240644 discloses a method for measuring the degree of translucency of an object's skin based on the luminance distribution of light which has been cast obliquely through a slit at the bottom of a housing onto the his or her skin and then has diffused under his or her skin.

Furthermore, Japanese Laid-Open Patent Publication No. 2011-130806 discloses a method for imaging light which has diffused inside an object's skin by cutting the light that has come directly from a light source with light casting means with a hole which contacts with his or her skin.

As disclosed in these documents, the degree of translucency of an object's skin or the sense of translucency his or her skin would give the viewer can be obtained by irradiating his or her skin with light and by measuring the quantity of light diffused inside his or her skin. That is to say, in this description, to measure the degree of translucency of an object's skin means measuring the degree of propagation of light (which will also be referred to herein as a “degree of light propagated”). In the following description, however, it will be described, in general terms used in the field of beauty treatments, how the measuring system of the present disclosure measures the degree of translucency.

### SUMMARY

However, since each of these conventional methods is designed to measure the degree of translucency in only a limited area of the object's skin, such a method cannot be used to measure the degree of translucency in a broad area (such as over the entire surface of his or her face) at multiple spots at a time.

A non-limiting exemplary embodiment of the present application provides a measuring system which can measure the degree of translucency in multiple areas of an object's skin at a time.

A measuring system according to an aspect of the present disclosure includes: a projecting section which is configured to project an image in a predetermined pattern as light within multiple regions of an object; an image capturing section which is configured to capture the object including those multiple regions; and an arithmetic section which is configured to calculate and output the degree of light propagated through those multiple regions of the object based on the object's image information that has been gotten by the image capturing section.

This general and particular aspect can be implemented as a system, a method, a computer program or a combination thereof.

A measuring system according to an aspect of the present disclosure can measure the degree of translucency in multiple areas of an object's skin at the same time.

These general and specific aspects may be implemented using a system, a method, and a computer program, and any combination of systems, methods, and computer programs.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

### BRIEF DESCRIPTION OF THE DRAWINGS

FIG. 1A is a schematic representation illustrating a first embodiment of a measuring system according to the present disclosure.

FIG. 1B illustrates an exemplary mask pattern.

FIG. 1C illustrates an object on which a pattern is projected.

FIG. 2 is a flowchart showing the procedure in which the measuring system of the first embodiment measures the degree of translucency.

FIGS. 3A to 3D illustrate images which have been obtained in Steps S12, S14, S15 and S18, respectively, in the flowchart shown in FIG. 2.

FIG. 4 is a cross-sectional view schematically illustrating how incident light diffuses under the surface of the skin in the first embodiment.

FIG. 5A is an image of a pattern being projected on a site on the skin where the degree of translucency is sensually high according to the first embodiment.

FIG. 5B is an image obtained by digitizing the image shown in FIG. 5A.

FIG. 5C is an image of a pattern being projected on a site on the skin where the degree of translucency is sensually low according to the first embodiment.

FIG. 5D is an image obtained by digitizing the image shown in FIG. 5C.

FIGS. 6A and 6B are schematic representations illustrating image capturing sections A for a second embodiment of a measuring system.

FIG. 7 is a flowchart showing the procedure in which the measuring system of the second embodiment measures the degree of translucency.

FIG. 8 is a schematic representation illustrating an image capturing section for use in a third embodiment of a measuring system.

FIGS. 9A and 9B are schematic representations illustrating an image capturing section for use in a fourth embodiment of a measuring system.

FIG. 10 is a schematic representation illustrating an image capturing section for use in a fifth embodiment of a measuring system.

FIG. 11A is a front view of the optical regions D1, D2, D3 and D4 of an optical element L1s as viewed from the object side in the image capturing section for use in the fifth embodiment.

FIG. 11B is a front view of the optical regions D1, D2, D3 and D4 of an optical element L1p as viewed from the object side.

FIG. 12 is a perspective view illustrating an array of optical elements K for an image capturing section for use in the fifth embodiment.

FIG. 13A is a illustrates the array of optical elements K and image sensor N shown in FIG. 10 and used in the fifth embodiment on a larger scale.

FIG. 13B shows the relative position of the array of optical elements K with respect to pixels on the image sensor N.

FIGS. 14A and 14B illustrate a sixth embodiment of a measuring system.

FIGS. 15A to 15F illustrate patterns to be projected onto the object in other embodiments.

FIGS. 16A to 16C illustrate the procedure of capturing an object with its position adjusted with respect to a guide pattern in another embodiment.

FIGS. 17A to 17C illustrate how to measure the distance to the object based on the magnitude of shift of sub-patterns which have been captured by the image capturing section in another embodiment.

FIGS. 18A and 18B are block diagrams illustrating configurations for measuring systems in other embodiments.

### DETAILED DESCRIPTION

An aspect of the present disclosure can be outlined as follows.

A measuring system according to an aspect of the present disclosure includes: a projecting section which is configured to project an image in a predetermined pattern as light within multiple regions of an object; an image capturing section which is configured to capture the object including those multiple regions; and an arithmetic section which is configured to calculate and output the degree of light propagated through those multiple regions of the object based on the object's image information that has been gotten by the image capturing section.

A measuring system according to another aspect of the present disclosure includes: a projecting section which is configured to project an image in a predetermined pattern that is made up of multiple sub-patterns as light within a specified region of an object; an image capturing section which is configured to capture the object including the specified region; and an arithmetic section which is configured to calculate the degree of light propagated through that specified region of the object based on the object's image information that has been gotten by the image capturing section.

The image capturing section may get a first piece of image information of the object onto which the image is projected and a second piece of image information of the object onto which the image is not projected. And the arithmetic section may generate a third piece of image information based on the difference between the first and second pieces of image information, and may calculate the degree of light propagated through the multiple regions or specified region of the object based on the third piece of image information.

The light may be red light, and the first and second pieces of image information may be color image information.

By capturing the object on which the image is projected, the image capturing section may get a second piece of image information which selectively includes the object and a third piece of image information which selectively includes the image that is projected on the object, and the arithmetic section may calculate the degree of light propagated through the multiple regions or specified region of the object based on the third piece of image information.

The light may be near-infrared light, the second piece of image information may be s color image information, and the third piece of image information may be near-infrared light image information.

The second and third pieces of image information may be gotten by capturing simultaneously the object on which the image is projected.

The image capturing section may include a first filter which either selectively cuts visible light or selectively transmits near-infrared light and a second filter which either selectively cuts near infrared light or selectively transmits visible light, and may get the third and second images using the first and second filters, respectively.

The image capturing section may include a first band-pass filter which selectively transmits light falling within a color red wavelength range, a second band-pass filter which selectively transmits light falling within a color green wavelength range, a third band-pass filter which selectively transmits light falling within a color blue wavelength range, and a fourth band-pass filter which selectively transmits light falling within a near infrared wavelength range, may get first, second, third and fourth pieces of image information using the first, second, third and fourth band-pass filters, may generate the second image based on the first, second and third pieces of image information, and may generate the third image based on the four piece of image information.

The light may be polarized light which oscillates along a first polarization axis, and the image capturing section may capture an image based on polarized light which oscillates along a second polarization axis that is different from the first polarization axis.

The arithmetic section may modulate portions of the second piece of image information representing the multiple regions or the specified region based on the degree of light propagated through the multiple regions or the specified region, and may output the second piece of image information that has been modulated.

The arithmetic section may change the color tone of the portions of the second piece of image information representing the multiple regions or the specified region.

The measuring system may further include a display section which displays either the second piece of image information or the second piece of image information that has been modulated.

The image capturing section, the projecting section and the display section may be arranged on substantially the same plane.

The predetermined pattern may include a plurality of striped sub-patterns.

The predetermined pattern may include a grating of sub-patterns to be projected onto the multiple areas, respectively.

The predetermined pattern may include an array of sub-patterns to be projected onto the multiple areas, respectively.

The predetermined pattern may be projected onto the entire face of the object.

The predetermined pattern may have no sub-patterns at positions corresponding to the right and left eyes of the face.

The arithmetic section may generate a guide pattern indicating the positions of the object's right and left eyes to display the guide pattern on the display section. The arithmetic section may detect the positions of the object's eyes in either the first or second piece of image information. And if the positions indicated by the guide pattern agree with the positions of the eyes, the arithmetic section may calculate the degree of light propagated.

The measuring system may further include an alerting section which outputs information that prompts the user of the system to move the object to a predetermined measuring position by reference to the interval between the object's right and left eyes as represented by the image information that has been gotten by the image capturing section.

The projecting section and the image capturing section may be arranged so as to be spaced apart from each other by a predetermined distance, and the measuring system may further include an alerting section which outputs information that prompts the user of the system to move the object to a predetermined measuring position by reference to the position of the predetermined pattern as represented by the image information that has been gotten by the image capturing section.

The measuring system may further include: a distance measuring section which measures the distance to the object by reference to the image information that has been gotten by the image capturing section; and an alerting section which outputs information that prompts the user of the system to move the object to a predetermined measuring position based on the distance to the object that has been measured.

The measuring system may further include a distance measuring section which measures the distance to the object by reference to the image information that has been gotten by the image capturing section, and the projecting section may change the degree of focus of the image in the predetermined pattern that is projected onto the object.

The predetermined pattern may include a distance-measuring sub-pattern to be projected onto the object.

A mobile telecommunications terminal according to still another aspect of the present disclosure includes: an image capturing section which is configured to capture an object's skin on which an image in a predetermined pattern is projected as light in multiple regions; an arithmetic section which is configured to calculate and output the degree of light propagated through the multiple regions on the object's skin based on the object's skin image information that has been gotten by the image capturing section; and a display section which displays the image information that has been gotten by the image capturing section.

A degree of translucency measuring method according to yet another aspect of the present disclosure includes the steps of: i) projecting a predetermined pattern on an object; ii) capturing the object; and iii) calculating and outputting the degree of light propagated through the object at multiple positions based on the object's image information that has been gotten in the step (ii).

Hereinafter, embodiments of a measuring system according to the present disclosure will be described with reference to the accompanying drawings.

### Embodiment 1

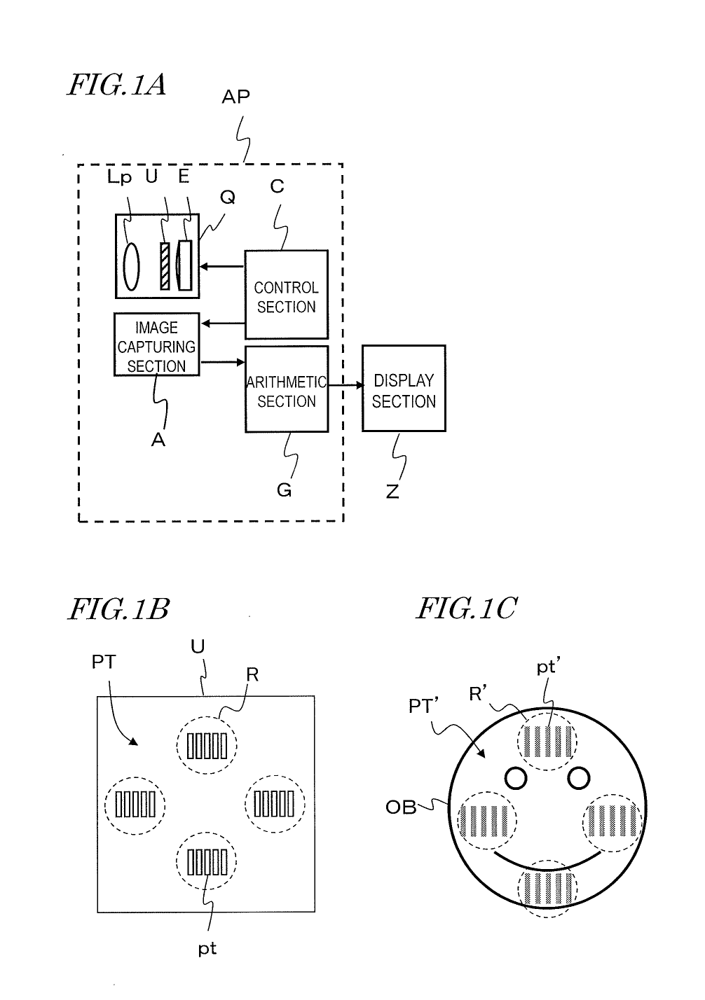

FIG. 1A is a schematic representation illustrating a configuration for a measuring system as a first embodiment of the present disclosure. The measuring system AP of this embodiment includes a projecting section Q, an image capturing section A, a control section C and an arithmetic section G.

In this embodiment, the object OB is a person's face. Also, in this embodiment, the measuring system AP is used under the condition that the object OB is illuminated with a room light.

The projecting section Q is configured to project a predetermined pattern as light onto a plurality of regions on the skin of the object OB. For that purpose, the projecting section Q includes a light source E, a mask U and a lens Lp.

As will be described later, the light source E emits a light beam falling within the color red wavelength range. Alternatively, the light source E may also be comprised of a light source which emits a white light beam and a filter which transmits a light beam falling within the color red wavelength range.

The mask U includes a light transmitting portion with a predetermined pattern PT. As shown in FIG. 1B, the predetermined pattern PT includes striped sub-patterns pt which are arranged in a plurality of region R.

The lens Lp converges the light beam that has been transmitted through the light transmitting portion of the mask U, thereby projecting an image of the predetermined pattern PT onto the object OB.

FIG. 1C schematically illustrates the predetermined pattern PT which has been projected onto the object OB. As shown in FIG. 1C, the image PT′ with the predetermined pattern includes striped sub-patterns pt′ which have been projected onto a plurality of regions R′ on the object's skin. The striped sub-pattern pt′ in each of those regions R′ includes a plurality of rectangular elements which are arranged at an interval of 5 mm to 15 mm, which have a width of 1 mm to 5 mm and a length of 10 mm to 30 mm, and which have been produced by the light beam falling within the color red wavelength range.

The image capturing section A includes an image sensor and captures the object OB, including the plurality of regions R′ on which the image PT′ is projected, and outputs an electrical signal. More specifically, the image capturing section A outputs a first piece of image information about the object's (OB) skin on which the image PT′ is projected and a second piece of image information about the object's (OB) skin on which the image PT′ is not projected. The image capturing section A senses the light beam falling within the color red wavelength range and generates the first and second pieces of image information. For example, the image capturing section A may generate first and second pieces of color image information.

The arithmetic section G is configured to calculate and output measured values representing the degrees of translucency of the object's (OB) skin in the plurality of regions R′ (which will be referred to herein as “degrees of light propagation”) based on the image information representing the object's (OB) skin that has been gotten by the image capturing section A. More specifically, the arithmetic section G generates differential image information representing the difference between the first and second pieces of image information provided by the image capturing section A and calculates measured values representing the degrees of translucency in those regions R′ on the skin. Optionally, based on the measured values representing the degrees of translucency of the skin thus calculated, the arithmetic section G may further modulate portions of the second piece of image information representing the multiple regions R′, and output the result of the modulation.

The measuring system AP outputs at least one of the measured values representing the degrees of translucency, the first piece of image information, the second piece of image information, and the modulated image information that have been calculated by the arithmetic section G to the display section Z.

The control section C controls these components of the measuring system AP. Optionally, the control section C and the arithmetic section G may be implemented as a combination of a computer such as a microcomputer and a program to execute the procedure of measuring the degree of translucency to be described below.

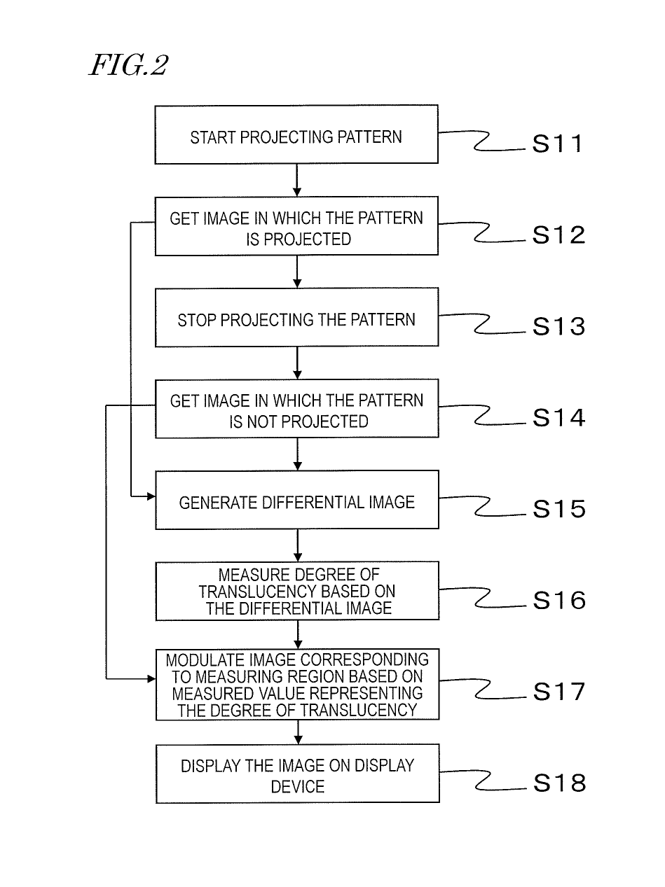

Next, it will be described in what procedure this measuring system AP operates and measures the degree of translucency of the object OB. FIG. 2 is a flowchart showing the procedure in which this measuring system AP operates and measures the degree of translucency. The control section C controls the respective components of the measuring system AP in order to measure the degree of translucency in the following procedure.

First of all, in Step S11, the projecting section Q is turned ON. As a result, an image PT′ is projected onto the object's (OB) skin.

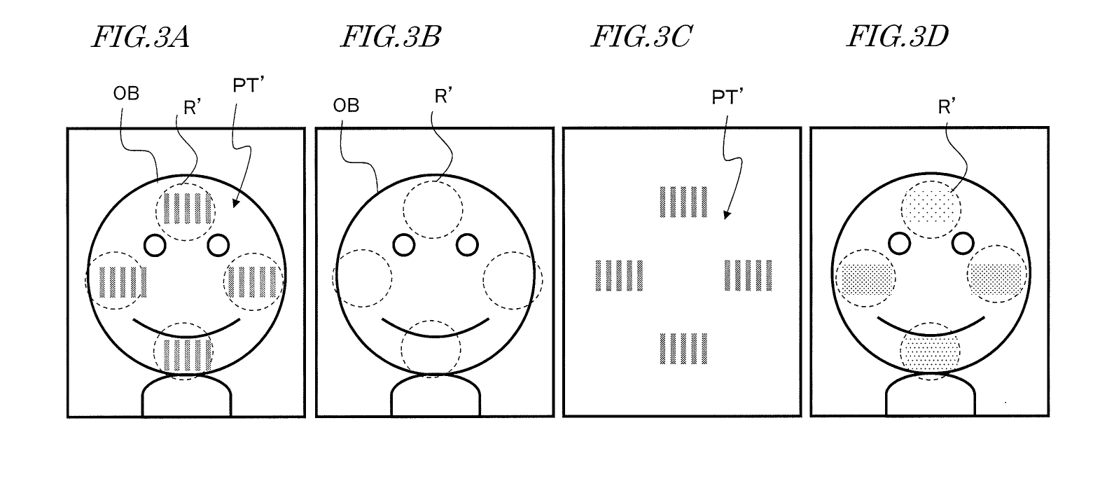

Next, in Step S12, the image capturing section A captures the object's (OB) skin, including those regions R′ on which the image PT′ is projected, thereby getting a first piece of image information. For example, the image information shown in FIG. 3A may be obtained as the first piece of image information.

Subsequently, in Step S13, the projecting section Q is either turned OFF or suspended to stop projecting the image PT′.

Thereafter, in Step S14, the image capturing section A captures the object's (OB) skin, including those regions R′ on which the image PT′ is not projected, thereby getting a second piece of image information. For example, the image information shown in FIG. 3B may be obtained as the second piece of image information.

Then, in Step S15, a third piece of image information representing the difference between the first and second pieces of image information that have been gotten in Steps S12 and S14, respectively, is generated. The third piece of image information may be generated by calculating the difference between the luminance values of corresponding pixels in the first and second pieces of image information, for example. FIG. 3C illustrates an example of the third piece of image information. Unless there is any motion in the object OB, the first and second pieces of image information shown in FIGS. 3A and 3B are almost the same except that the image PT′ is projected there or not. That is why by calculating their difference, only a luminance distribution produced by the projected pattern of the image PT′ can be extracted. For that reason, the control section C may control the projecting section Q and the image capturing section A so as to get these processing steps S12 to S14 done in a shorter time.

Next, in Step S16, the degrees of translucency of the skin are measured in those regions R′ which are irradiated with the pattern based on the differential image information that has been generated in Step S15. Now, it will be described by way of illustrative examples specifically how to measure the degrees of translucency. FIG. 4 is a cross-sectional view schematically illustrating how a projected light beam J which has been incident on the skin surface diffuses under the surface of the skin. The longer the wavelength of the light beam that has been incident on the skin, the deeper inside the light beam reaches by diffusion. As shown in FIG. 4, the incident light beam diffuses and reaches farther in the order of the wavelengths of the colors B (blue), G (green), and R (red) light beams and NIR (near infrared) light beam. That is why the longer the wavelength, the more easily the degree of diffusion can be seen. Also, the higher the degree of translucency, the farther the incident light beam reaches by diffusion. Part of the light that has diffused will go out through the surface of the skin again.

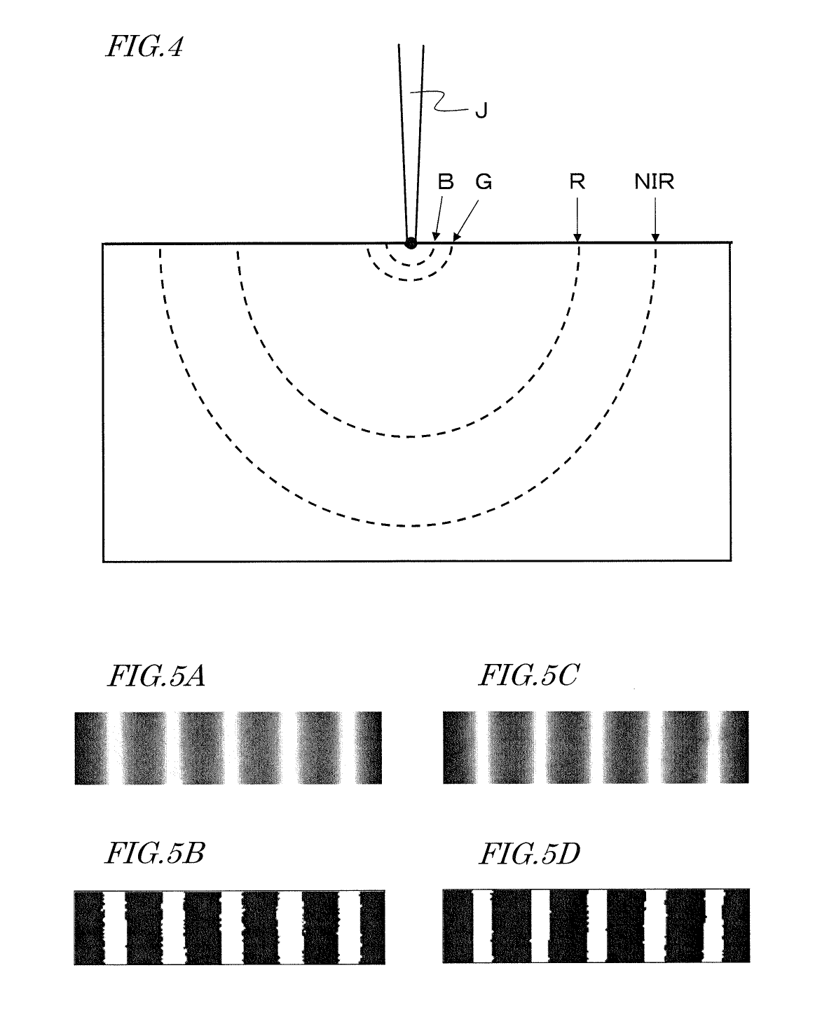

To confirm such a principle, the present inventors carried out an experiment with a red light striped pattern projected onto the skin. FIGS. 5A and 5C show pieces of the third piece of image information (differential image information) which have been gotten by performing the series of processing steps S11 through S15 shown in FIG. 2, and are a piece of image information obtained from a site on the skin where the degree of translucency is sensually high and from a site on the skin where the degree of translucency is sensually low, respectively. Comparing these images shown in FIGS. 5A and 5C to each other, it can be seen that the image shown in FIG. 5A has stripes with the broader width, which indicates that the degree of diffusion is the greater. FIGS. 5B and 5D are images obtained by digitizing the images shown in FIGS. 5A and 5C, respectively. The image shown in FIG. 5B has white stripes with the broader width than the other image. Thus, the degree of translucency can be obtained based on either the width of the white stripes or the ratio of the width of the white striped to that of the black stripes.

To increase the precision of measurement of the measured values representing the degrees of translucency, the widths of each stripe may be measured at multiple points in the direction in which that stripe runs and their average may be calculated. Or the widths of multiple stripes falling within the same region R′ may be measured and their average may be calculated. In the case of the subject OB shown in FIG. 1C, striped patterns are projected onto four regions on his or her face, and therefore, the degrees of translucency can be measured in those four regions R′. If necessary, the number of the regions R′ on which the striped sub-pattern images pt′ are projected may be increased.

Either the strip width or the average of the multiple stripe widths thus obtained may be used as the measured value representing the degree of translucency. In this case, generally speaking, the greater the width value, the deeper inside the skin the light in the striped pattern that has been projected from the projecting section Q will reach by diffusion. That is to say, it means that the greater the width value, the higher the degree of translucency will be. Alternatively, the ratio of the width of the stripes to the interval between the stripes may be obtained as a duty ratio, which may be used as a measured value representing the degree of translucency. In that case, even if the image PT′ projected onto the object's (OB) skin is zoomed in or out depending on the distance between the projecting section Q and the object OB, the measured value representing the degree of translucency can also be obtained with the influence of the size of the image PT′ minimized. Still alternatively, stripe widths may be obtained in advance with respect to multiple objects and either a table of correspondence between the stripe widths and indices to the degrees of translucency or a function representing their correspondence may be drawn up and stored in the arithmetic section G. In that case, the measured value representing the degree of translucency is determined by reference to the table or the function with the stripe width obtained.

Then, in Step S17, the second piece of image information that has been gotten in Step S14 is modulated based on the measured value representing the degree of translucency. Specifically, in the region R′ on which the image PT′ of the first piece of image information is projected, the second piece of image information is modulated according to the measured value representing the degree of translucency. More specifically, the image information is modulated so that a color tone changes into the color blue, green or red, for example, according to the measured value representing the degree of translucency. For example, to modulate the image information so that the color tone changes into the color blue, the gain of the color blue component of the color image information may be increased or the gains of the colors green and red components thereof may be decreased. FIG. 3D illustrates an example of the second piece of image information that has been modulated. Inside the rectangular regions in the regions R′, the second piece of image information has been modulated and the difference in the depth of the shade (hatching) represents the difference in their color.

Finally, in Step S18, the second piece of image information that has been generated in Step S17 is presented on the display section Z such as a liquid crystal display.

As can be seen from the foregoing description, the measuring system AP of this embodiment can measure the degrees of translucency of the object's skin in multiple regions at the same time. In addition, by modulating the object's skin image information according to the measured value representing the degree of translucency and presenting the modulated image information on the display section, either the object him- or herself who is subjected to this skin check or the operator can sense the degree of translucency of his or her skin intuitively.

Even though the projecting section Q is supposed to project a red light striped pattern, a light beam in any other color may also be used. For example, a near infrared light beam may also be used.

Also, the image information does not have to be modulated by changing the color tone. Alternatively, the image information may also be modulated by adjusting the brightness of the entire image information or the gamma correction value of the image information. Or the measured value representing the degree of translucency may be presented on the display section Z. The regions to be modulated in Step S17 do not have to be rectangular regions but may also be circular or elliptical regions as well.

Furthermore, although the measuring system AP is supposed to be used under a room light in the embodiment described above, the measuring system AP may further include an illumination unit to irradiate the object with light.

Furthermore, the projecting section Q may project a pattern of light which oscillates along a first polarization axis and the image capturing section A may get image information of light which oscillates along a second polarization axis which is different from the first polarization axis. To realize such a configuration, a polarization filter which transmits a polarized light beam that oscillates along the first polarization axis may be arranged on the optical path of the projecting section Q and a polarization filter which transmits a polarized light beam that oscillates along the second polarization axis may be arranged on the optical path of the image capturing section A. If the skin is irradiated with a light beam which oscillates along a predetermined polarization axis, then the light reflected from the surface of the skin will be specular reflected light which maintains the original polarization components. On the other hand, the light reflected from under the surface of the skin will be scattered reflected light with disturbed polarization components. That is why if the first and second pieces of image information are gotten based on the polarized light oscillating along the second polarization axis by adopting this configuration, the light that has been specular reflected from the surface of the skin can be removed and only the light diffusing under the surface of the skin can be extracted. As a result, the degree of translucency can be measured more accurately. If the first and second polarization axes intersect with each other at right angles, the light that is specular reflected from the surface of the skin can be removed most efficiently.

Even though the lens Lp of the projecting section Q is illustrated as a single lens, the lens Lp may also be made up of multiple lenses. Optionally, a Fresnel lens or diffraction lens with positive power may be inserted between the light source E and the mask U in order to guide the light to the lens Lp efficiently.

### Embodiment 2

In a measuring system as this second embodiment, the patterned light projected from the projecting section Q is near infrared light and the image capturing section A gets the color image information and near infrared light image information at the same time, which are differences from the measuring system of the first embodiment described above. Thus, the following description of this second embodiment will be focused on these differences from the measuring system of the first embodiment.

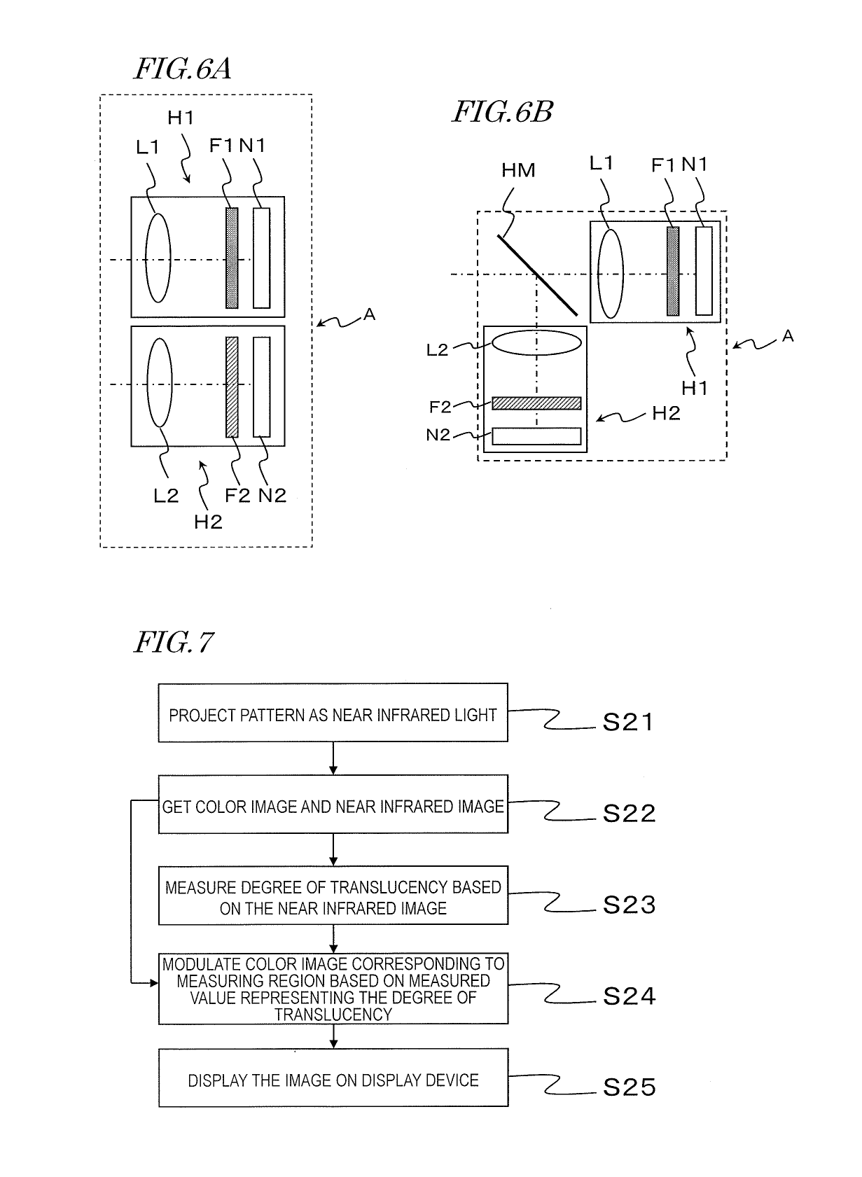

FIG. 6A is a schematic representation illustrating an image capturing section A for the measuring system AP of this embodiment. This image capturing section A is comprised of a first image capturing optical system H1 including a lens L1, a near infrared light cut filter (or visible light transmitting filter) F1 and a color image sensor N1 and a second image capturing optical system H2 including a lens L2, a visible light cut filter (or near infrared light transmitting filter) F2 and a monochrome image sensor N2.

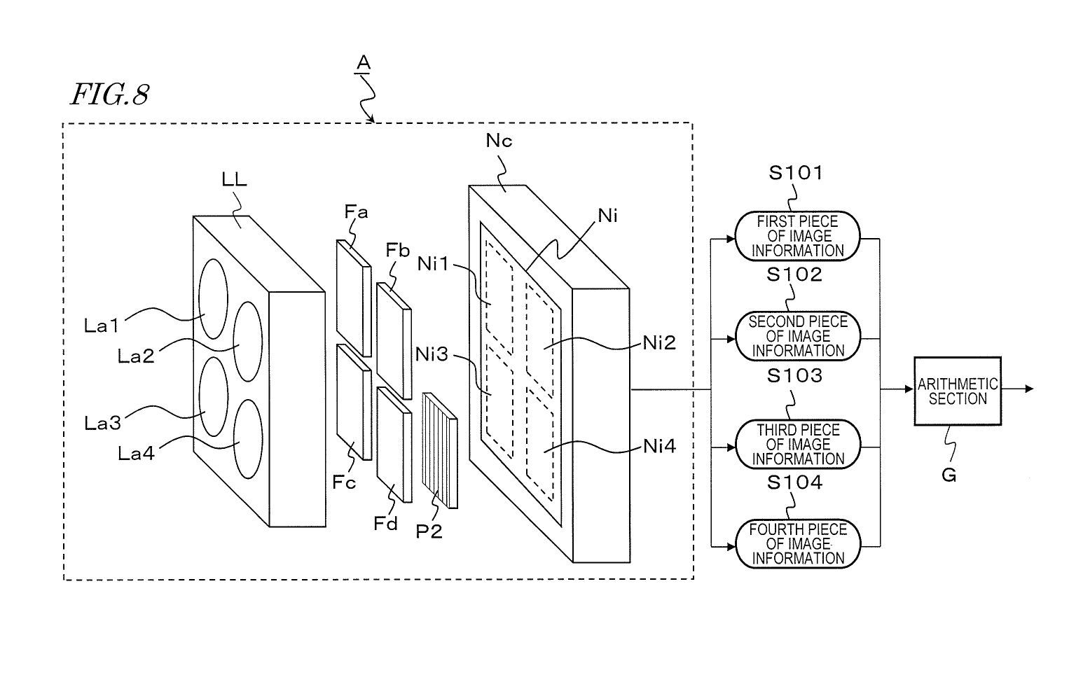

Next, it will be described in what procedure the measuring system AP of this embodiment operates and measures the degree of translucency of the object OB. FIG. 7 is a flowchart showing the procedure in which the measuring system AP of this embodiment measures the degree of translucency.

First of all, in Step S21, the projecting section Q projects a predetermined pattern as a near infrared beam onto the object's skin. As a result, an image PT′ is projected as a near infrared beam onto the object OB.

Next, in Step S22, the first and second image capturing optical systems H1 and H2 of the image capturing section A respectively capture a color image and a monochrome image of the object OB on which the image PT′ is projected. Since the near infrared light cut filter F1 is arranged on the optical path of the first image capturing optical system H1, the first image capturing optical system H1 can capture a color image selectively including the object OB image on which the image PT′ is not produced, i.e., the second image. On the other hand, since the visible light cut filter F2 is arranged on the optical path of the second image capturing optical system H2, the second image capturing optical system H2 can capture an image selectively including the image PT′ that is projected as near infrared light. This image does not include the object (OB) image and corresponds to a third image that is a differential image according to the first embodiment. The color second image and the monochrome third image can be captured by capturing the object simultaneously.

Next, in Step S23, the measuring system AP obtains measured values representing the degrees of translucency at four spots as in Step S16 of the first embodiment described above.

Subsequently, in Step S24, the measuring system AP modulates the region R′ of the color image based on the measured values representing the degrees of translucency as in Step S17 of the first embodiment described above.

And then in Step S25, the image information that has been generated in Step S24 is presented on the display section Z such as a liquid crystal display.

The measuring system of this embodiment can also measure the degrees of translucency in multiple regions of the object at the same time as in the first embodiment described above. In addition, according to this embodiment, since a color image of the object OB and a monochrome image on which only the projected image PT′ has been produced can be captured at the same time, the position of the modulated image will never shift due to a time lag.

Since the first and second image capturing optical systems H1 and H2 are arranged so as to be spaced apart from each other by a predetermined distance, parallax is produced between the color image of the object OB and the monochrome image consisting of only the image PT′. However, since the object located at a predetermined position is shot when the degree of translucency is measured with the measuring system, the distance between the object and the measuring system falls roughly within a predefined particular range. That is why the magnitude of parallax between the first and second image capturing optical systems H1 and H2 also falls within a predetermined range. For that reason, the region R′ may be defined so as to be shifted by the magnitude of parallax corresponding to the expected object distance, and the color image of the object OB in the shifted region R′ may be modulated. In addition, since the differential image can be obtained without being affected by such parallax, the measured value representing the degree of translucency is not affected by the parallax at all.

Optionally, the image capturing section A may have a different configuration. FIG. 6B illustrates a configuration for the image capturing section A which uses a half mirror HM. In the image capturing section A shown in FIG. 6B, the light that has come from the object OB has its optical path split by the half mirror HM. Specifically, part of the incoming light is transmitted through the half mirror HM and then incident on the first image capturing optical system H1. On the other hand, the rest of the incoming light is reflected from the half mirror HM and then incident on the second image capturing optical system H2. As described above, the first and second image capturing optical systems H1 and H2 capture a color image of the object OB and a monochrome image of the image PT′ being projected onto the object OB, respectively. According to such a configuration, no parallax is produced, and therefore, there is no need to correct the parallax, unlike the configuration shown in FIG. 6A.

Alternatively, the half mirror HM shown in FIG. 6B may also be replaced with a dichroic mirror which transmits visible light and which reflects near infrared light. In that case, the near infrared light cut filter F1 and the visible light cut filter F2 are no longer necessary and the light that has come from the object can be received and used efficiently.

Also, as in the first embodiment described above, the projecting section Q may project a pattern of light oscillating in the first polarization axis direction, and the image capturing section A may capture an image of light oscillating in the second polarization axis direction that is different from the first polarization axis direction. In that case, a polarization filter which transmits light oscillating in the second polarization axis direction may be arranged on the optical path of the second image capturing optical system H2 of the image capturing section A. By adopting such a configuration, the light to be specular reflected from the surface of the skin can be removed, only the light that has diffused under the surface of the skin can be extracted, and the degree of translucency can be measured more accurately.

### Embodiment 3

In the measuring system of this third embodiment, the image capturing section A has a different configuration from its counterpart of the measuring system of the second embodiment described above. Thus, the following description of this third embodiment will be focused on this difference from the measuring system of the second embodiment described above.

FIG. 8 is a schematic representation illustrating an image capturing section A for a measuring system according to this third embodiment. The image capturing section A of the measuring system AP of this embodiment includes a fly-eye lens LL, a band-pass filter Fa which transmits mostly a light beam falling within the color red wavelength range, a band-pass filter Fb which transmits mostly a light beam falling within the color green wavelength range, a band-pass filter Fc which transmits mostly a light beam falling within the color blue wavelength range, a band-pass filter Fd which transmits mostly a light beam falling within the near infrared wavelength range, a second polarization filter P2 which transmits mostly a light beam oscillating in the second polarization axis direction, and an image sensor Nc.

In the fly-eye lens LL, four lenses La1, La2, La3 and La4 are arranged on the same plane. Meanwhile, on the image capturing plane Ni on the image sensor Nc, image capturing areas Ni1, Ni2, Ni3 and Ni4 have been defined so as to face one to one the lenses La1, La2, La3 and La4, respectively.

Also, the band-pass filters Fa, Fb, Fc and Fd are arranged so that the light beams that have been transmitted through the lenses La1, La2, La3 and La4 pass through the band-pass filters Fa, Fb, Fc and Fd and are incident on the image capturing areas Ni1, Ni2, Ni3 and Ni4, respectively.

This image capturing section A captures the object (not shown) through four optical paths, namely, an optical path leading to the image capturing area Ni1 via the lens La1 and the band-pass filter Fa transmitting mainly a light beam falling within the color red wavelength range, an optical path leading to the image capturing area Ni2 via the lens La2 and the band-pass filter Fb transmitting mainly a light beam falling within the color green wavelength range, an optical path leading to the image capturing area Ni3 via the lens La3 and the band-pass filter Fc transmitting mainly a light beam falling within the color blue wavelength range, and an optical path leading to the image capturing area Ni4 via the lens La4 and the band-pass filter Fd transmitting mainly a light beam falling within the near infrared wavelength range.

By adopting such a configuration, first, second, and third pieces of image information S101, S102 and S103 including pieces of information about light beams falling within the colors red, green and blue third wavelength ranges, respectively, and a fourth piece of image information S104 including a piece of information about a light beam falling within the near infrared wavelength range and oscillating in the second polarization axis direction are obtained from the image capturing areas Ni1, Ni2, Ni3 and Ni4, respectively.

According to this embodiment, the lenses La1, La2, La3 and La4 are arranged so as to be spaced apart from each other, and therefore, parallax corresponding to the object distance is produced between the images captured in the image capturing areas Ni1, Ni2, Ni3 and Ni4. That is why if either a color image or an image obtained by modulating a color image based on the measured value representing the degree of translucency needs to be generated, then the arithmetic section G may synthesize the respective images together after having corrected their parallax. Specifically, using the first piece of image information S101 as a reference image, parallax corrected images of the second, third and fourth pieces of image information S102, S103 and S104 may be generated and then synthesized together. An image portion may be extracted by performing pattern matching on each image on a micro-block basis, and then the image may be shifted by the magnitude of the parallax that has been extracted on a micro-block basis. In this manner, the parallax corrected image information can be generated.

By adopting such a configuration, a color image can be generated by synthesizing the first, second and third pieces of image information S101, S102 and S103 together. In addition, the degree of translucency of the object's skin is measured based on the fourth piece of image information S104 and the color image is modulated as in the second embodiment described above based on the measured value representing the degree of translucency.

According to this embodiment, the degrees of translucency can be measured in multiple regions on the same object at the same time as in the first embodiment described above. In addition, according to this embodiment, since a color image representing the object OB and a monochrome image including only the image PT′ can be obtained at the same time as in the second embodiment, the position of the modulated image will never shift due to a time lag.

On top of that, this third embodiment has a configuration in which the fly-eye lens LL is arranged on the single image sensor Nc. That is why compared to the configurations of the first and second embodiments, the image capturing section A can have a smaller volume and the measuring system can have a smaller overall size.

### Embodiment 4

In the measuring system of this fourth embodiment, the image capturing section A has a different configuration from its counterpart of the measuring systems of the second and third embodiments described above. Thus, the following description of this fourth embodiment will be focused on this difference from the measuring systems of the second and third embodiments described above.

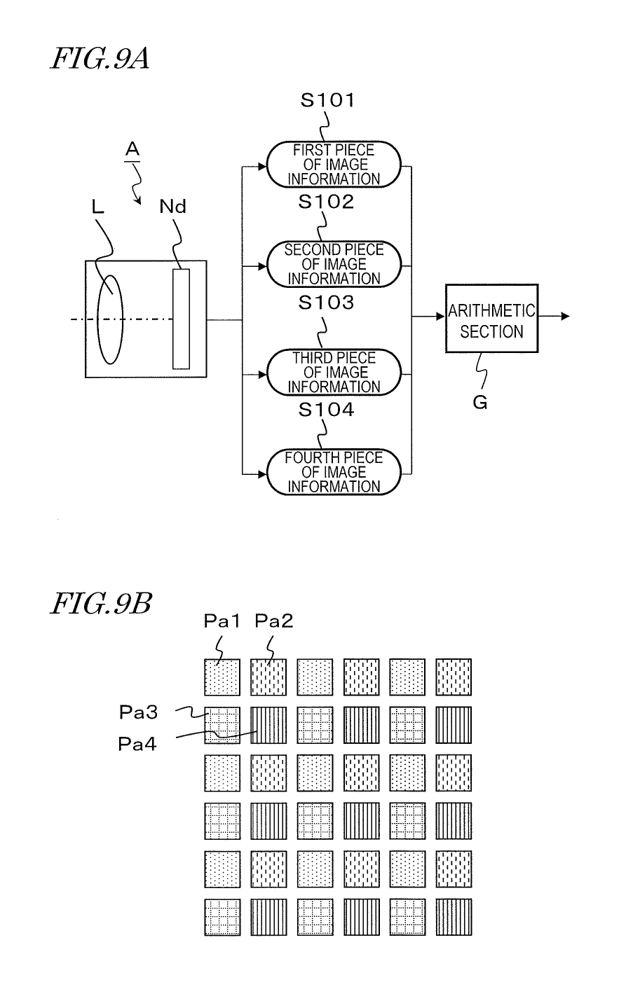

FIG. 9A is a schematic representation illustrating an image capturing section A for the measuring system of this embodiment. The image capturing section A of the measuring system AP of this embodiment includes a lens L and an image sensor Nd. FIG. 9B illustrates an arrangement of pixels on the image sensor Nd. As shown in FIG. 9B, in the image sensor Nd of this embodiment, a band-pass filter which selectively transmits mostly a light beam falling within the color red wavelength range is provided for the pixel Pa1. In the same way, band-pass filters which selectively transmit mostly a light beam falling within the color green wavelength range and a light beam falling within the color blue wavelength range, respectively, are provided for the pixels Pa2 and Pa3. On the other hand, a band-pass filter which selectively transmits mostly a light beam falling within the near infrared wavelength range and a polarization filter which selectively transmits mostly a light beam oscillating in the second polarization axis direction are provided for the pixel Pa4. The band-pass filters provided for these pixels are implemented as an absorptive filter or a filter of a multilayer dielectric film, and the polarization filter is implemented as a wire-grid polarizer. These pixels Pa1, Pa2, Pa3 and Pa4 may be arranged in two rows and two columns, for example. And these four pixels are arranged to form the same pattern a number of times in the row and column directions in this image sensor Nd.

In capturing an object (not shown), the light beam that has come from the object passes through the lens L and then reaches the image sensor Nd. Since a band-pass filter which transmits mostly a light beam falling within the color red wavelength range is provided for the pixel Pa1, the first piece of image information S101 including a piece of information about the light beam falling within the color red wavelength range can be generated by extracting only an electrical signal generated by the pixel Pa1. In the same way, by extracting electrical signals generated by the pixels Pa2 and Pa3, the second and third pieces of image information S102 and S103 including pieces of information about light beams falling within the colors green and blue wavelength ranges, respectively, can be generated. On the other hand, since a band-pass filter which transmits mostly a light beam falling within the near infrared wavelength range and a polarization filter which transmits mostly a light beam oscillating in the second polarization axis direction are provided for the pixel Pa4, the fourth piece of image information S104 including a piece of information about the light beam oscillating in the second polarization axis direction and falling within the near infrared wavelength range can be generated by extracting only an electrical signal generated by the pixel Pa4.

Color image information can be generated by synthesizing together the first, second and third pieces of image information S101, S102 and S103 that have been obtained by using such a configuration. In addition, the degree of translucency is measured based on the fourth piece of image information S104 and the color image information is modulated as in the second embodiment described above based on the measured value representing the degree of translucency.

By adopting such a configuration, the degrees of translucency can be measured in multiple regions on the same object at the same time as in the first embodiment described above. In addition, according to this embodiment, since a color image representing the object OB and a monochrome image including only the image PT′ can be obtained at the same time as in the second and third embodiments, the position of the modulated image will never shift due to a time lag.

On top of that, this fourth embodiment has a configuration in which the lens L is arranged on the single image sensor Nd. That is why compared to the configuration of the second embodiment, the image capturing section A can have a smaller volume and the measuring system can have a smaller overall size.

### Embodiment 5

In the measuring system of this fifth embodiment, the image capturing section A has a different configuration from its counterpart of the measuring system of the second, third or fourth embodiment described above. Thus, the following description of the fifth embodiment will be focused on differences from the measuring system of the second embodiment described above.

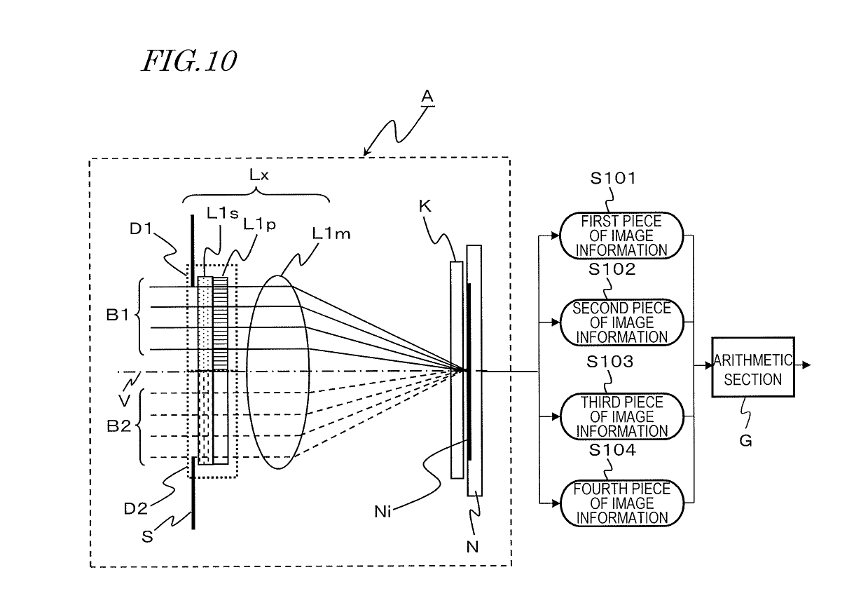

FIG. 10 is a schematic representation illustrating the image capturing section A of the measuring system of this embodiment. The image capturing section A of this embodiment includes a lens optical system Lx, of which the optical axis is indicated by V, an array of optical elements K which is arranged in the vicinity of the focal point of the lens optical system Lx, and a monochrome image sensor N.

The lens optical system Lx includes a stop S on which the light that has come from the object (not shown) is incident, optical elements L1s, L1p on which the light that has passed through the stop S is incident, and a lens L1m that the light that has passed through the optical elements L1s, L1p enters. As will be described in detail later, the lens optical system Lx has optical regions D1, D2, D3 and D4.

The lens L1m may be comprised of either a single lens or multiple lenses. In the latter case, those lenses may be arranged separately in front of, and behind, the stop S. In the example illustrated in FIG. 10, the lens L1m is illustrated as a single lens.

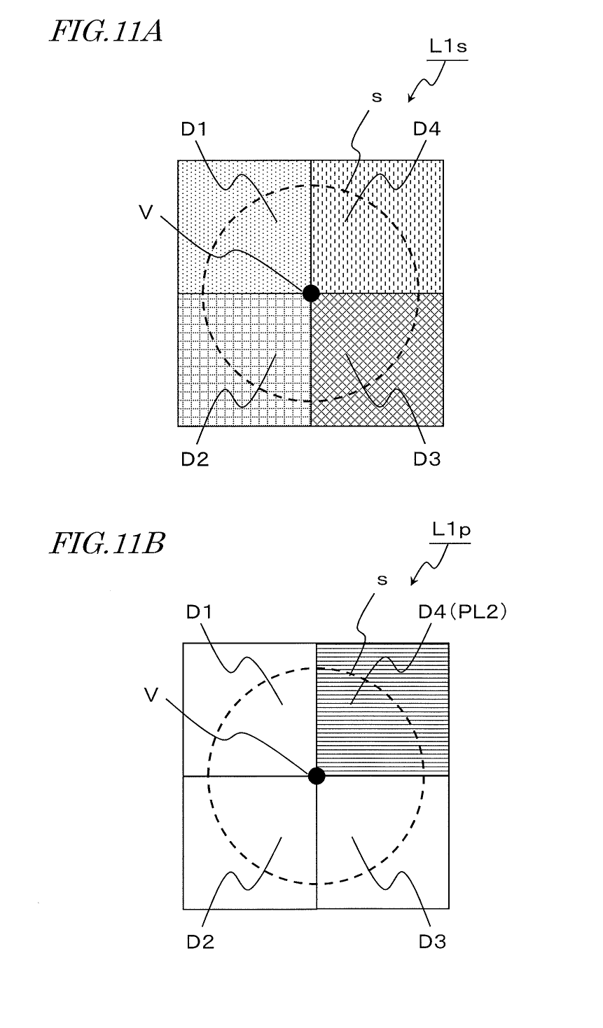

FIG. 11A is a front view of the optical element L1s as viewed from the object side. The optical element L1s is arranged to cover the optical regions D1, D2, D3 and D4, which are four regions that are parallel to the optical axis V and that have been divided by two planes passing through the optical axis V and intersecting with each other at right angles. Portions of the optical element L1s which are located in these optical regions D1, D2, D3 and D4 have mutually different spectral transmittance characteristics. The optical element L1s is arranged between the stop S and the optical element L1p. In these optical regions D1, D2, D3 and D4 of the optical element L1s, arranged are four regions which mainly transmit light beams falling within the colors red, green and blue wavelength ranges and a light beam falling within the near-infrared wavelength range, respectively.

FIG. 11B is a front view of the optical element L1p as viewed from the object side. The optical element L1p has a polarization filter PL2 which transmits mostly a light beam oscillating parallel to the second polarization axis in only a region corresponding to the optical region D4 and has a glass plate which transmits a light beam that oscillates in any direction in each of the other regions. Optionally, the glass plate may be omitted as well.

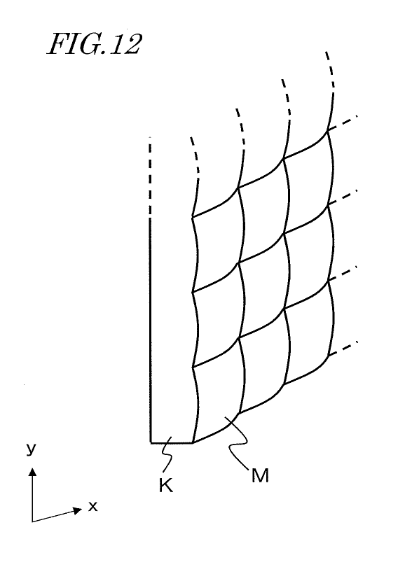

FIG. 12 is a perspective view illustrating an array of optical elements K. On the surface of the array of optical elements K, optical elements M are arranged in a grating pattern so as to face the image sensor N. Each of these optical elements M has a curved cross section in both of the x and y directions shown in FIG. 12, and projects toward the image sensor N. As can be seen, these optical elements M are micro lenses to make this array of optical elements K a micro lens array.

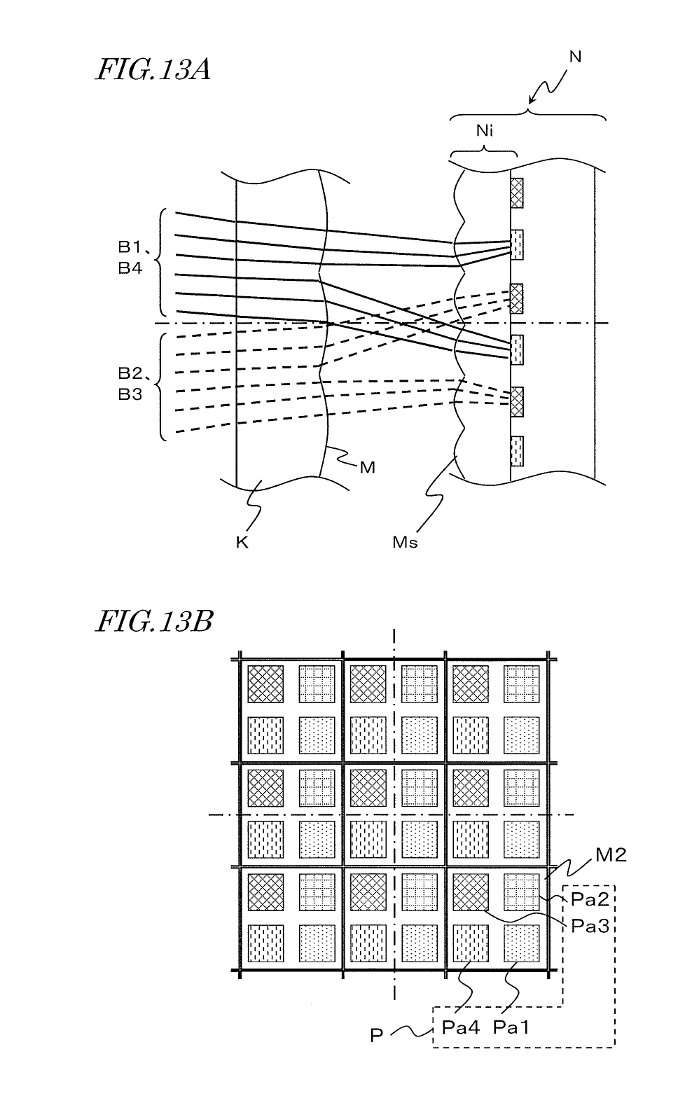

FIG. 13A illustrates a cross section of the array of optical elements K and the image sensor N on a larger scale, and FIG. 13B shows the relative position of the array of optical elements K with respect to the pixels on the image sensor N. The array of optical elements K is arranged so that the optical elements M on its surface face the image capturing plane Ni. On the image capturing plane Ni, pixels P are arranged in columns and rows. Those pixels P can be grouped into pixels Pa1, Pa2, Pa3 and Pa4.

The array of optical elements K is arranged in the vicinity of the focal point of the lens optical system Lx and at a predetermined distance from the image capturing plane Ni. On the image capturing plane Ni, micro lenses Ms are arranged so that each of those micro lenses Ms covers the surface of its associated one of the pixels Pa1, Pa2, Pa3 and Pa4.

The array of optical elements K is designed so that most of the light beams which have passed through the optical regions D1, D2, D3 and D4 of the optical elements L1s and L1p reach the pixels Pa1, Pa2, Pa3 and Pa4 on the image capturing plane Ni. Specifically, by appropriately setting the refractive index of the array of optical elements K, the distance from the image capturing plane Ni, the radius of curvature of the surface of the optical elements M and other parameters, such a configuration is realized.

That is why mostly a light beam that falls within the color red wavelength range and that has been split by being transmitted through the optical region D1 is incident on the pixel Pa1 and a first piece of image information S101 consisting essentially of information about the light beam falling within the color red wavelength range can be generated by extracting only an electrical signal representing the pixel Pa1. In the same way, second and third pieces of image information S102 and S103 consisting essentially of information about the light beams falling within the colors green and red wavelength ranges, respectively, can be generated by extracting only electrical signals representing the pixels Pa2 and Pa3, respectively. Meanwhile, mostly a light beam which falls within the near infrared wavelength range and oscillates parallel to the second polarization axis and which has been split by being transmitted through the optical region D4 is incident on the pixel Pa4 and a fourth piece of image information S104 consisting essentially of information about the light beam oscillating in the second polarization axis direction and falling within the near infrared wavelength range can be generated by extracting only an electrical signal representing the pixel Pa4.

Based on the first, second, third and fourth pieces of image information S101, S102, S103 and S104 which have been generated with such a configuration, color image information is synthesized. Also, the degree of translucency of the object's skin is measured based on the fourth piece of image information S104, and the color image information is modulated based on the measured value representing the degree of translucency as in the second embodiment described above.

According to this embodiment, the degrees of translucency can be measured at multiple spots on the same object at the same time as in the first embodiment described above. In addition, according to this embodiment, since a color image representing the object OB and a monochrome image including only the image PT′ can be obtained at the same time as in the second, third and fourth embodiments, the position of the modulated image will never shift due to a time lag.

### Embodiment 6

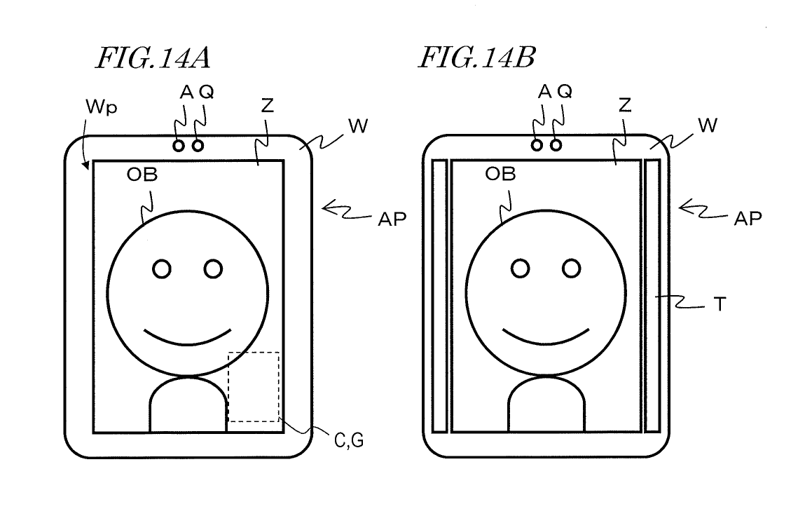

FIG. 14A illustrates a measuring system AP. The measuring system AP of this embodiment includes a projecting section Q, an image capturing section A, a control section C, an arithmetic section G, a display section Z and a housing W. Among these members, the projecting section Q, image capturing section A, control section C, and arithmetic section G may have the same configuration as their counterparts of the measuring system AP of any of the first through fifth embodiments described above.

The housing W has an opening which has been cut through the plane top wp to leave an internal space inside, and may have a size of a tablet terminal, for example, which is small enough to be held by the user in his or her hands. In the internal space of the housing W, the projecting section Q, image capturing section A, control section C, arithmetic section G and display section Z are housed. Also, as shown in FIG. 14A, the projecting section Q, image capturing section A, and display section Z are arranged on the plane top Wp. Unlike the first through fifth embodiments described above, the arithmetic section G transforms the image data so that a mirror-inverted version of the image captured by the image capturing section A is displayed on the display section Z.

In the measuring system AP of this embodiment, a mirror-inverted version of the captured image is displayed on the display section Z. Thus, the user him- or herself who is the object of this measuring system can check out his or her own mirror image as if this system were a normal mirror. In addition, the function of measuring the degree of translucency allows the user him- or herself to sense the degree of translucency of his or her own skin intuitively.

The measuring system AP of this embodiment may further include an illumination unit T to illuminate the object with light. For example, the illumination unit T may be arranged on the plane top wp adjacent to the display section Z as shown in FIG. 14B. The measuring system AP may include two illumination units T which are arranged to interpose the display section Z between them, or may include only one illumination unit or even three or more illumination units as well.

Optionally, in the measuring system AP of this embodiment, the projecting section Q may be arranged outside of the housing W. Specifically, the measuring system AP may be a personal digital assistant (PDA) such as a smart phone or a tablet terminal which is a mobile telecommunications device with a camera and a display section. In that case, the projecting section Q is connected to the input/output terminal of the PDA and projects an image with a predetermined pattern as light onto multiple regions on the object based on the power and control signal supplied from the PDA. The image capturing section A of the PDA captures the object, on which the image with the predetermined pattern is projected as light on multiple regions on the skin. The arithmetic section G calculates and outputs measured values representing the degrees of translucency of object's skin in those multiple regions based on the object's skin image information that has been gotten by the image capturing section A. And the display section Z inverts the image that has been captured by the image capturing section and displays a mirror-inverted version of the image as described above.

### Other Embodiments

In the embodiments described above, the predetermined pattern PT of the mask U in the projecting section is supposed to include striped sub-patterns which are arranged at the upper, lower, right and left ends of the mask U as shown in FIG. 1B. However, the pattern to be projected does not have to have such a shape.

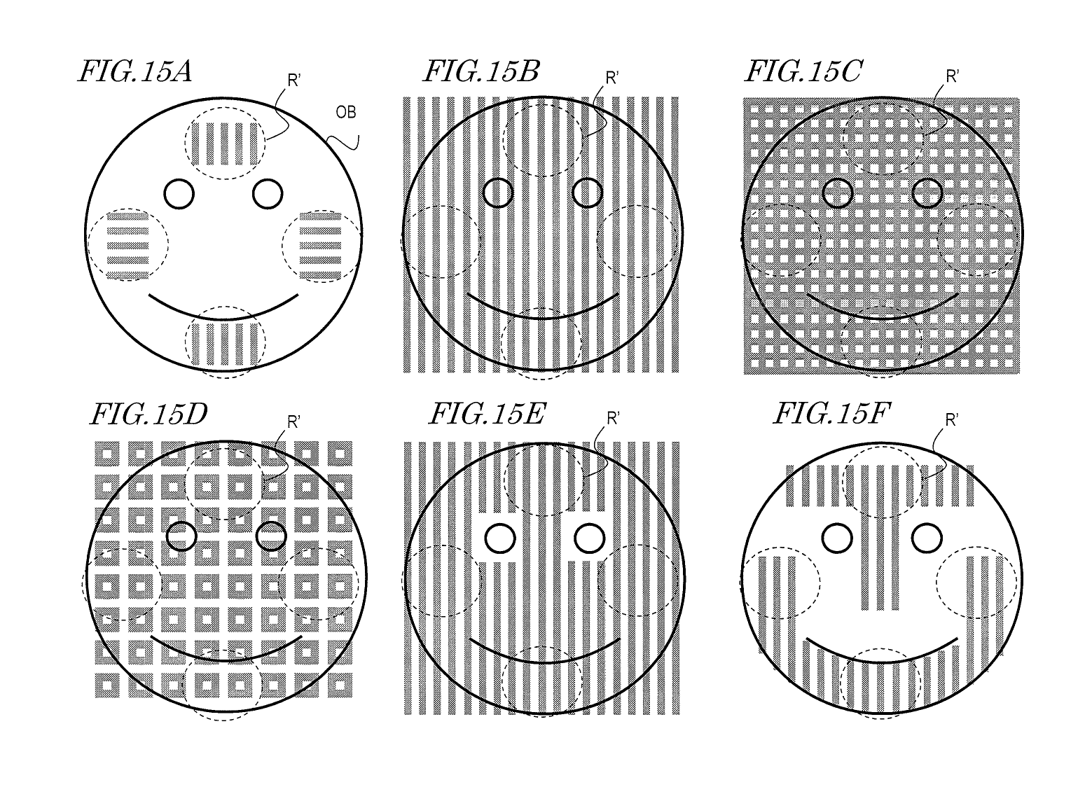

FIGS. 15A through 15F illustrate other exemplary image patterns to be projected onto those regions R′ of the object OB. For example, as shown in FIG. 15A, the sub-patterns projected onto the respective regions R′ may have a striped shape but the direction in which the stripes run in the regions R′ at the upper and lower ends of the object OB may be different by 90 degrees from the direction in which the stripes run in the regions R′ at the right and left ends of the object OB. Specifically, the striped sub-patterns projected onto the forehead and lower jaw regions R′ of the object OB may have stripes that run vertically, while the striped sub-patterns projected onto the cheek regions R′ of the object OB may have stripes that run horizontally. In the case of the projection pattern shown in FIG. 1C, if a lens with relatively large astigmatism such as a single lens were used as the lens L of the projection optical system, the resolution of the striped patterns at the upper and lower ends could be different from that of the striped patterns at the right and left ends due to the influence of the astigmatism and the degrees of translucency measured could be different from each other. On the other hand, if the projection patterns shown in FIG. 15A are used, such a variation in the degrees of translucency measured due to the astigmatism can be suppressed. By using such projection patterns, a single lens may be used as the lens L of the projecting section and the cost of the projecting section can be cut down.

Also, as shown in FIGS. 15B, 15C and 15D, as long as the sub-pattern is projected onto those regions R′, the sub-pattern does not have to be made up of separate ones but may form a single continuous pattern. In that case, the pattern is projected from the projecting section Q onto the entire object OB to produce an image there. FIG. 15B illustrates an example in which the pattern projected onto the object OB has a striped shape. In this case, the measured value representing the degree of translucency of the skin can be obtained as in the first embodiment described above. On the other hand, in the case of the grid pattern shown in FIG. 15C and the multi-square pattern shown in FIG. 15D, differential image information may be obtained and the image information may be digitized as in the first embodiment, and then the measured value representing the degree of translucency may be obtained based on the sum of the dark areas of the image information (i.e., the sum of the respective areas of the square regions). By adopting such a projected pattern, the degree of translucency can be measured over the entire face.

Alternatively, the projecting section Q may also project a pattern such as the one shown in FIG. 15E so that regions corresponding to the right and left eyes of the object's face are irradiated with no light projected from the projecting section. By adopting such a projection pattern, the degree of translucency of the object's skin can be measured without getting him or her dazzled. Still alternatively, a projection pattern such as the one shown in FIG. 15F may also be adopted so that patterns are projected onto T and U zones of the face and that no patterns are projected onto regions corresponding to the right and left eyes of the object's face.

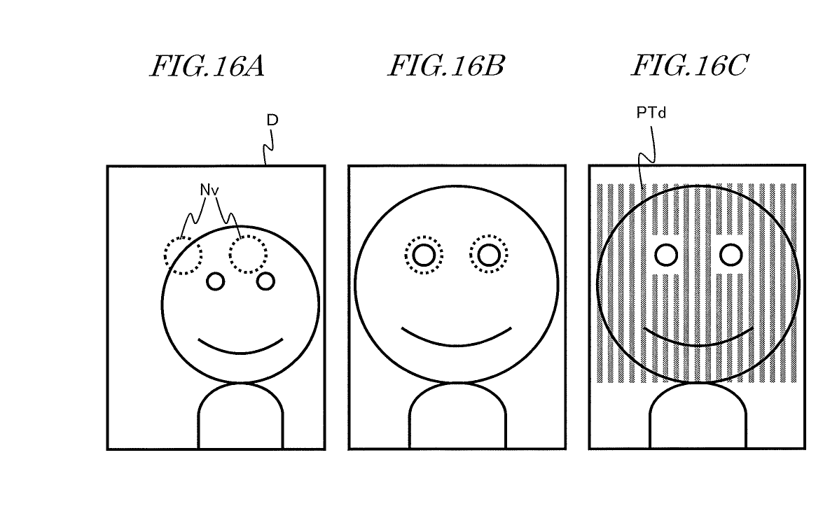

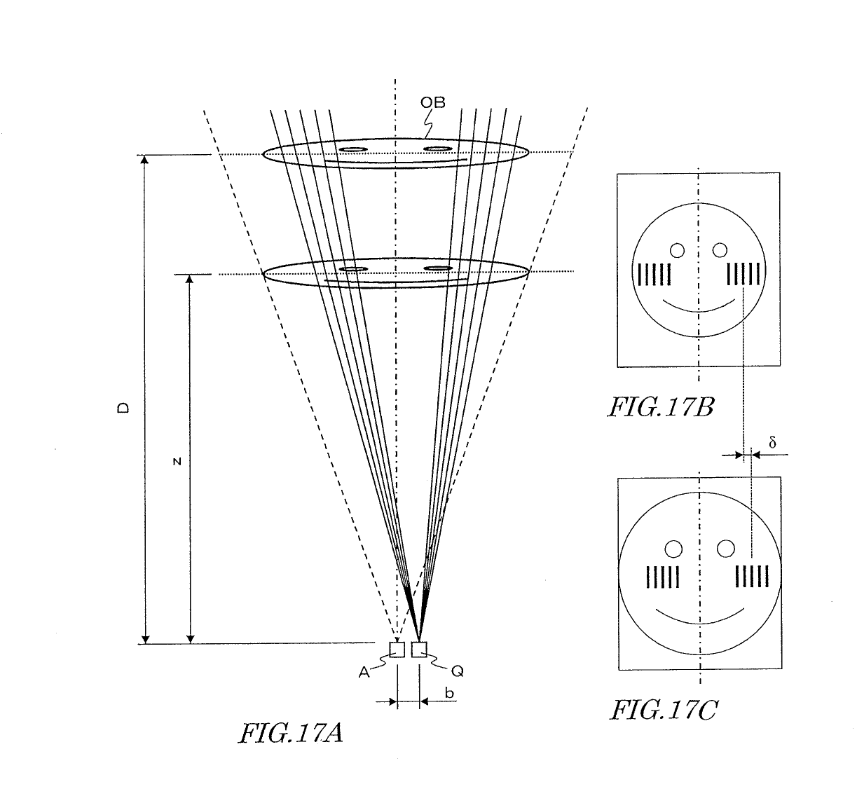

Also, to prevent any pattern from being projected onto regions corresponding to the right and left eyes of the object's face as in the patterns shown in FIGS. 15E and 15F, the object's face needs to be moved to a predetermined position in advance. To do this, a guide pattern Nv indicating the positions of the object's eyes during the measurement may be displayed in advance on the display section Z as shown in FIG. 16A. And when the object's face moved reaches a position where his or her right and left eyes fall within the ranges indicated by the guide pattern Nv as shown in FIG. 16B, the pattern is projected. As a result, no patterns will be projected onto those regions corresponding to the right and left eyes of the object's face as shown in FIG. 16C. By adopting such a configuration, the degree of translucency can be measured at substantially the same position every time, and therefore, the past measuring data can be referred to correctly.

Furthermore, if the distance between the object and the projecting section Q changes every time the measurement is made and if the size of the pattern projected onto the object changes, then the size of the pattern projected onto the object may be adjusted by reference to the image information that has been gotten by capturing the object. Specifically, the interval between the right and left eyes of the object is measured by reference to the image information that has been gotten on the supposition that the interval between a human being's eyes is substantially constant. Since the distance between the object and the image capturing section A can be estimated based on the measured value, the position of the projecting section Q may be controlled and the size of the pattern projected onto the object may be adjusted based on the distance estimated.

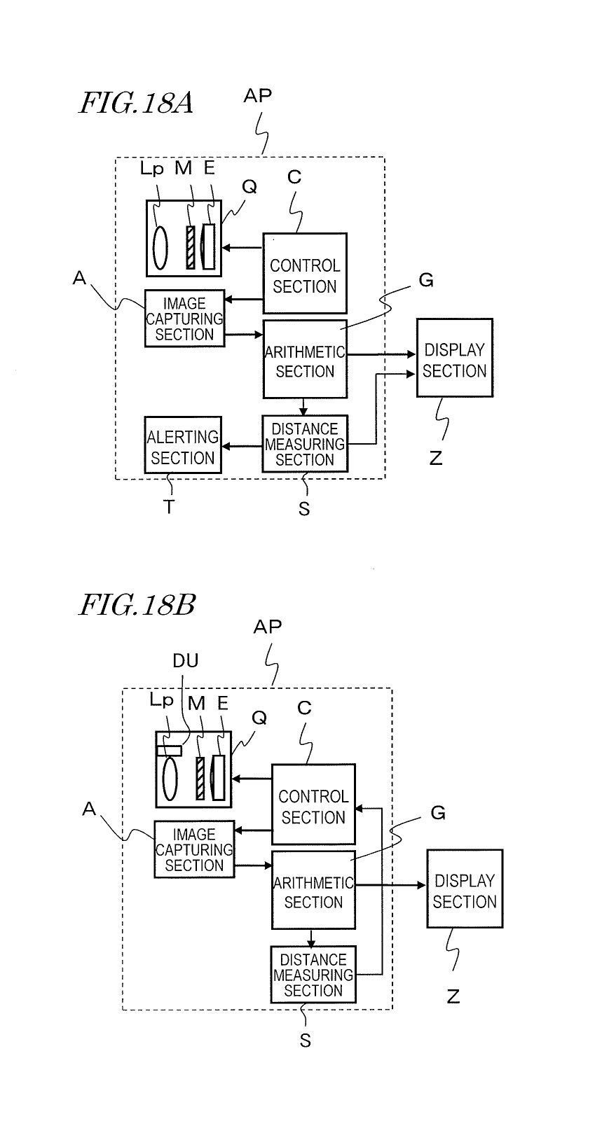

Also, to estimate the distance between the object and the image capturing section A, the image capturing section A and the projecting section Q may be arranged so as to be spaced apart from each other by a predetermined distance, and the distance to the object may be measured based on the magnitude of shift of the sub-patterns that have been captured by the image capturing section A. FIGS. 17A to 17C illustrate how to measure the distance to the object based on the magnitude of shift of the sub-patterns that have been captured by the image capturing section A. Specifically, FIG. 17A shows the relative positions of the image capturing section A, the projecting section Q and the object OB. The regular measuring position is set so that when the image capturing section A and the projecting section Q are arranged so as to be spaced apart from each other by the distance b, the object OB is located at a distance D from the image capturing section A. In that case, an image such as the one shown in FIG. 17B is obtained.

If the object OB is not located at the regular measuring position but is located at a distance z from the image capturing section A, an image such as the one shown in FIG. 17C is obtained. In this case, the sub-patterns are captured so that their centers have shifted by δ with respect to the positions shown in FIG. 17B. In this case, δ can be obtained by performing pattern matching on the image. In this case, supposing the focal length of the lens of the image capturing section A is f, the relation represented by the following Equation (1) is obtained by modifying the equation of triangulation:

$$\frac{b}{z} - \frac{b}{D} = \frac{δ}{f} \qquad ( 1 )$$

Consequently, the distance z to the object can be derived based on the relation represented by this Equation (1).

As shown in FIG. 18A, the measuring system may include a distance measuring section S which estimates or derives the distance in the procedure described above, and an alerting section T which outputs information to be used to move the object (such as the direction and distance of movement of the object) based on the distance measured so that the object is arranged at the regular measuring position, and may be configured to prompt the object him- or herself to move. Alternatively, instead of using the alerting section T, information about the direction or distance of movement of the object may also be displayed on the display section Z as characters, numerals, or an icon or sign such as an arrow sign. Still alternatively, information about the direction or distance of movement of the object may also be output as audio information. Even though such information to be used to move the object is supposed to be output in the foregoing description based on the distance to the object for convenience sake, the alerting section T may output information to be used to move the object directly based on the interval between his or her eyes or the δ value.

Alternatively, based on the distance measured, the projecting section Q may change the size of the image PT′ with the predetermined pattern that is being projected onto the object OB. For that purpose, the projecting section Q may further include a driving unit DU to drive the lens Lp as shown in FIG. 18B. The distance measuring section S derives the distance z to the object and outputs the distance z to the control section C. Based on the given distance z, the control section C outputs a drive signal to the driving unit DU and changes the position of the lens Lp so that the size of the image PT′ with the predetermined pattern projected on the object OB becomes an appropriate size to measure the degree of translucency.

Still alternatively, the projecting section Q may also change the degree of focusing of the image PT′ with the predetermined pattern being projected onto the object OB based on the distance measured. In that case, the projecting section Q may further include a driving unit DU to drive the lens Lp as in the example just described. The distance measuring section S derives the distance z to the object and outputs the distance z to the control section C. Based on the given distance z, the control section C outputs a drive signal to the driving unit DU and changes the position of the lens Lp so that the image PT′ with the predetermined pattern projected on the object OB comes into focus.

In the exemplary configuration described above, the same sub-pattern is used in common to measure the degree of translucency and to measure the distance to the object. However, a dedicated sub-pattern for use exclusively to measure the distance to the object may be provided separately.

Also, although a method for measuring the degree of translucency based on the width or area of the pattern of digitized image information has been described, a predetermined area of image information with a striped pattern may be subjected to a Fourier transform and a response value with respect to a predetermined frequency may be measured as the degree of translucency.

Furthermore, in the first through sixth embodiments described above, the arithmetic section G of the measuring system is illustrated as being arranged near the image capturing section A of the measuring system. However, the arithmetic section G may also be arranged distant from the spot of measurement. For example, image information data obtained from the image capturing section A may be transmitted over a telecommunications line such as the Internet to an arithmetic section G which is located distant from the measuring system and which functions via a server or host computer that is connected to the telecommunications line. Also, data of the measured value representing the degree of translucency which has been obtained by the arithmetic section G or modulated image information may be transmitted to the spot of measurement over the telecommunications line and the display section Z installed at that spot may display the image information modulated.

A measuring system according to an aspect of the present disclosure is applicable for use in a skin checker system, for example.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

What is claimed is:

1. A measuring system comprising:
a projecting section which is configured to project an image in a predetermined pattern as light within multiple regions of an object;
an image capturing section which is configured to capture the object including those multiple regions; and
an arithmetic section which is configured to calculate and output the degree of light propagated through those multiple regions of the object based on the object's image information that has been gotten by the image capturing section.

2. A measuring system comprising:
a projecting section which is configured to project an image in a predetermined pattern that is made up of multiple sub-patterns as light within a specified region of an object;
an image capturing section which is configured to capture the object including the specified region; and
an arithmetic section which is configured to calculate the degree of light propagated through that specified region of the object based on the object's image information that has been gotten by the image capturing section.

3. The measuring system of claim 1, wherein the image capturing section gets a first piece of image information of the object onto which the image is projected and a second piece of image information of the object onto which the image is not projected, and
the arithmetic section generates a third piece of image information based on the difference between the first and second pieces of image information, and calculates the degree of light propagated through the multiple regions or specified region of the object based on the third piece of image information.

4. The measuring system of claim 3, wherein the light is red light, and
the first and second pieces of image information are color image information.

5. The measuring system of claim 1, wherein by capturing the object on which the image is projected, the image capturing section gets a second piece of image information which selectively includes the object and a third piece of image information which selectively includes the image that is projected on the object, and
the arithmetic section calculates the degree of light propagated through the multiple regions or specified region of the object based on the third piece of image information.

6. The measuring system of claim 5, wherein the light is near-infrared light,
the second piece of image information is color image information, and
the third piece of image information is near-infrared light image information.

7. The measuring system of claim 6, wherein the second and third pieces of image information are gotten by capturing simultaneously the object on which the image is projected.

8. The measuring system of claim 4, wherein the arithmetic section modulates portions of the second piece of image information representing the multiple regions or the specified region based on the degree of light propagated through the multiple regions or the specified region, and outputs the second piece of image information that has been modulated.

9. The measuring system of claim 8, wherein the arithmetic section changes the color tone of the portions of the second piece of image information representing the multiple regions or the specified region.

10. The measuring system of claim 3, further comprising a display section which displays either the second piece of image information or the second piece of image information that has been modulated.

11. The measuring system of claim 10, wherein the image capturing section, the projecting section and the display section are arranged on substantially the same plane.

12. The measuring system of claim 1, wherein the predetermined pattern includes a plurality of striped sub-patterns.

13. The measuring system of claim 10, wherein the arithmetic section generates a guide pattern indicating the positions of the object's right and left eyes to display the guide pattern on the display section,
the arithmetic section detects the positions of the object's eyes in either the first or second piece of image information, and
if the positions indicated by the guide pattern agree with the positions of the eyes, the arithmetic section calculates the degree of light propagated.

14. The measuring system of claim 1, further comprising an alerting section which outputs information that prompts the user of the system to move the object to a predetermined measuring position by reference to the interval between the object's right and left eyes as represented by the image information that has been gotten by the image capturing section.

15. The measuring system of claim 1, wherein the projecting section and the image capturing section are arranged so as to be spaced apart from each other by a predetermined distance, and
the system further includes an alerting section which outputs information that prompts the user of the system to move the object to a predetermined measuring position by reference to the position of the predetermined pattern as represented by the image information that has been gotten by the image capturing section.

16. The measuring system of claim 1, further comprising: a distance measuring section which measures the distance to the object by reference to the image information that has been gotten by the image capturing section; and an alerting section which outputs information that prompts the user of the system to move the object to a predetermined measuring position based on the distance to the object that has been measured.

17. A mobile telecommunications terminal comprising:
an image capturing section which is configured to capture an object's skin on which an image in a predetermined pattern is projected as light in multiple regions;
an arithmetic section which is configured to calculate and output the degree of light propagated through the multiple regions on the object's skin based on the object's skin image information that has been gotten by the image capturing section; and
a display section which displays the image information that has been gotten by the image capturing section.

18. A measuring method comprising:
i) projecting a predetermined pattern on an object;
ii) capturing the object; and
iii) calculating and outputting the degree of light propagated through the object at multiple positions based on the object's image information that has been gotten in the step (ii).
